(19) United States
(12) Patent Application Publication
(10) Pub. No.: US 2023/0349514 A1
(43) Pub. Date: Nov. 2, 2023

(54) CRYOGENIC CHAMBER WITH MULTI-DOOR ACCESSIBILITY

(71) Applicant: Honeywell International Inc., Charlotte, NC (US)

(72) Inventors: Neal Staley, New Brighton, MN (US); Kyle Zilic, Minneapolis, MN (US); Michael Peterson, Charlotte, NC (US)

(21) Appl. No.: 18/296,398

(22) Filed: Apr. 6, 2023

Related U.S. Application Data
(60) Provisional application No. 63/363,854, filed on Apr. 29, 2022.

(51) Int. Cl. F17C 13/00

(52) U.S. Cl. CPC F17C 13/002; F17C 2205/03; F17C 2250/0626; F17C 2250/0631; F17C 2203/032; F17C 13/001

(57) ABSTRACT

A environmental control chamber device comprising a vacuum chamber, a controller, and at least one door is described. In an embodiment, the vacuum chamber is defined at an upper face, four or more lateral faces, and a lower face. The at least one door is connected to a respective one of the four or more lateral faces. The four or more lateral faces comprise at least one opening, and the at least one door is configured to seal the at least one opening. The controller is configured to control a pressure and a temperature within the vacuum chamber. The pressure may be a vacuum pressure, and the temperature may be a cryogenic temperature. Each door comprises a peripherally-lined seal configured to maintain a pressure within the vacuum chamber, and one or more radiation shields configured to maintain the temperature within the vacuum chamber.

### CROSS-REFERENCE TO RELATED APPLICATIONS

This application claims priority to U.S. Provisional Application No. 63/363,854, filed Apr. 29, 2022, the contents of which are hereby incorporated herein in its entirety by reference.

### FEDERALLY SPONSORED RESEARCH OR DEVELOPMENT

This invention was made with United States Government support. The United States Government has certain rights in the invention.

### TECHNICAL FIELD

Various embodiments relate to an environmental control chamber device with improved accessibility. For example, various embodiments relate to an environmental control chamber device comprising at least one door configured to allow insertion, access, removal, modification, and/or the like of a payload for the environmental control chamber device.

### BACKGROUND

In various scenarios, an action (e.g., experiment, quantum particle controlled state evolution, reaction, performance of a function, systems and/or component testing, and/or the like) is to be carried out under controlled environmental conditions and/or environmental conditions that are not generally ambient conditions on Earth. Some of these actions require control of environmental parameters such as temperature, pressure, and/or the like. For example, it may be required and/or desirable to carry out an action at a cryogenic temperature (e.g., less than 124 K) and/or at vacuum or near-vacuum pressure (e.g., less than 14.7 psi) in order to prevent perturbations and/or errors caused by environmental noise. Such actions are carried out by and/or performed on a payload (e.g., an object, subject, device, system, component, and/or the like) in a cryogenic vacuum environment. Occasionally, such actions may require modification or adjustment of the payload during the time course of the action and/or between performance of actions, and such modifications or adjustments are required to be performed within a short time frame.

### BRIEF SUMMARY OF EXAMPLE EMBODIMENTS

Various embodiments provide an environmental control chamber device and/or corresponding components and/or methods. For example, example embodiments provide an environmental control chamber device comprising at least one door, an environmental control chamber device having a payload disposed within and comprising at least one door, a door for use with an environmental control chamber device, a method of operating an environmental control chamber device comprising at least one door, and/or the like. In various example embodiments, the environmental control chamber device may comprise a vacuum chamber within which the payload may be stored, disposed, positioned, operated, and/or used to perform one or more actions at a vacuum pressure and a cryogenic temperature. In various example embodiments, the environmental control chamber device comprises at least one door enabling access to the payload.

According to a first aspect, an environmental control chamber device is provided. The environmental control chamber device includes a vacuum chamber. The vacuum chamber is defined by four or more lateral faces, an upper face, and a lower face. The four or more lateral faces include at least one opening. The environmental control chamber device further includes a controller configured to control a pressure and a temperature within the vacuum chamber. The environmental control chamber device further includes at least one door. The at least one door is connected to a respective one of the four or more lateral faces and is configured to seal the at least one opening.

In an example embodiment, the controller is configured to control the pressure within the vacuum chamber to a vacuum pressure (e.g., less than 14.7 psi) and to control the temperature within the vacuum chamber to a cryogenic temperature (e.g., less than 124 K). In an example embodiment, each lateral face of the four or more lateral faces of the vacuum chamber includes an opening, and the environmental control chamber device includes four or more doors, each door connected to a respective one of the four or more lateral faces and corresponding to the opening of the respective lateral face. In an example embodiment, the vacuum chamber is defined by six lateral faces, an upper face, and a lower face, each lateral face of the six lateral faces including an opening, and the environmental control chamber device includes six doors, each door connected to a respective one of the six lateral faces and corresponding to the opening of the respective lateral face.

In an example embodiment, the at least one door is moveable (e.g., rotatable, slidable, and/or the like) between an open state and a closed state. The at least one door is configured to maintain the pressure and the temperature within the vacuum chamber when positioned in a closed state and is configured to enable access into the vacuum chamber when positioned in an open state. In an example embodiment, the at least one door includes a peripherally-lined seal that is configured to maintain the pressure within the vacuum chamber. In an example embodiment, the at least one door includes one or more radiation shields that are configured to maintain the temperature within the vacuum chamber and/or to reduce stray electric and/or magnetic fields within the vacuum chamber. In an example embodiment, the at least one door includes two or more radiation shields that are nested and/or layered radiation shields.

In an example embodiment, the at least one opening is configured to be smaller than a respective lateral face. The at least one opening is further configured such that an area of the at least one opening is maximized, and the at least one door is dimensioned based at least in part on the at least one opening. In an example embodiment, the at least one opening is dimensioned based at least in part on a payload to be stored, disposed, positioned, operated, and/or used to perform one or more actions in the vacuum chamber. In an example embodiment, the upper face includes one or more access ports, the one or more access ports configured to enable access to an interior volume of the vacuum chamber by at least one of (i) electrical wires, (ii) optical fibers and/or beam paths, (iii) fluid lines, (iv) an optical imaging device, or (v) mechanical feedthroughs. In an example embodiment, the at least one door and/or at least one of the four or more lateral faces includes one or more access ports. In an example embodiment, the one or more access ports are configured to enable access to an interior volume of the vacuum chamber by at least one of (i) electrical wires, (ii) optical fibers and/or beam paths, (iii) fluid lines, (iv) an optical imaging device, or (v) mechanical feedthroughs. In an example embodiment, the one or more access ports are transparent at a wavelength or wavelength range of interest of an optical imaging device positioned exterior to the vacuum chamber. In an example embodiment, the controller is configured to control movement of the at least one door. In an example embodiment, the controller is configured to determine a closed or open state of the at least one door through a door sensor.

According to another aspect, a method of operating an environmental control chamber device including a vacuum chamber, a controller, and at least one door is provided. The method includes opening the at least one door. The at least one door is connected to a respective one of four or more lateral faces defining the vacuum chamber. The method further includes, after a payload has been inserted into an interior volume of the vacuum chamber or accessed within the vacuum chamber through at least one opening of the four or more lateral faces corresponding to the at least one door, determining that the at least one door is closed. The method further includes determining an operation pressure and an operation temperature for the vacuum chamber, and causing the interior volume of the vacuum chamber to have the determined operation pressure and the determined operation temperature. In an example embodiment, the determined operation pressure is a vacuum pressure (e.g., less than 14.7 psi) and the determined operation temperature is a cryogenic temperature (e.g., less than 124 K). In an example embodiment, the controller causes a pressure control system and/or a temperature control system to reduce a pressure within the vacuum chamber to the determined operation pressure and/or to reduce a temperature within the vacuum chamber to the determined operation temperature.

In an example embodiment, each lateral face of the four or more lateral faces of the vacuum chamber includes an opening, and the environmental control chamber device includes four or more doors, each door connected to a respective one of the four or more lateral faces and corresponding to the opening of the respective lateral face. In an example embodiment, the vacuum chamber is defined by six lateral faces, an upper face, and a lower face, each lateral face of the six lateral faces includes an opening, and the environmental control chamber device includes six doors, each door connected to a respective one of the six lateral faces and corresponding to the opening of the respective lateral face.

In an example embodiment, the at least one door is moveable (e.g., rotatable, slidable, and/or the like) between an open state and a closed state. The at least one door is configured to maintain the determined operation pressure and the determined operation temperature within the vacuum chamber when positioned in a closed state and is configured to enable access into the vacuum chamber when positioned in an open state. In an example embodiment, the at least one door includes a peripherally-lined seal that is configured to maintain the determined operation pressure within the vacuum chamber. In an example embodiment, the at least one door includes one or more radiation shields that are configured to maintain the determined operation temperature within the vacuum chamber and/or to reduce stray electrical and/or magnetic fields within the vacuum chamber. In an example embodiment, the at least one door includes two or more radiation shields that are nested and/or layered radiation shields.

In an example embodiment, the at least one opening is configured to be smaller than a respective lateral face. The at least one opening is further configured such that an area of the at least one opening is maximized, and the at least one door is dimensioned based at least in part on the dimensions of the at least one opening. In an example embodiment, the at least one opening is dimensioned based at least in part on a payload to be stored, disposed, positioned, operated, and/or used to perform one or more actions in the vacuum chamber. In an example embodiment, the upper face includes one or more access ports, the one or more access ports configured to enable access to an interior volume of the vacuum chamber by at least one of (i) electrical wires, (ii) optical fibers and/or beam paths, (iii) fluid lines, (iv) an optical imaging device, or (v) mechanical feedthroughs. In an example embodiment, the at least one door and/or at least one of the four or more lateral faces includes one or more access ports. In an example embodiment, the one or more access ports are configured to enable access to an interior volume of the vacuum chamber by at least one of (i) electrical wires, (ii) optical fibers and/or beam paths, (iii) fluid lines, (iv) an optical imaging device, or (v) mechanical feedthroughs. In an example embodiment, the one or more access ports are transparent at a wavelength or wavelength range of interest of an optical imaging device positioned exterior to the vacuum chamber. In an example embodiment, the controller is configured to control movement of the at least one door. In an example embodiment, the controller is configured to determine a closed or open state of the at least one door through a door sensor. In an example embodiment, causing the interior volume of the vacuum chamber to have the determined operation pressure and the determined operation temperature is based at least in part on determining that the at least one door is positioned in a closed state based at least in part on a signal generated by a door sensor associated with the at least one door.

According to yet another aspect, an apparatus for operating an environmental control chamber device is provided. The apparatus includes at least one memory and one processor, the at least one memory storing instructions that when executed by the processor, cause the apparatus to open at least one door of the environmental control chamber device. The at least one door is connected to a respective one of four or more lateral faces defining a vacuum chamber of the environmental control chamber device. The apparatus is further caused to, after a payload has been inserted into an interior volume of the vacuum chamber and/or has been accessed through at least one opening of the four or more lateral faces corresponding to the at least one door, determine that the at least one door is closed. The apparatus is further caused to determine an operation pressure and an operation temperature for the vacuum chamber, and to cause the vacuum chamber to have the determined operation pressure and the determined operation temperature. In an example embodiment, the determined operation pressure is a vacuum pressure (e.g., less than 14.7 psi), and the determined operation temperature is a cryogenic temperature (e.g., less than 124 K). In an example embodiment, a controller of the environmental control chamber device causes a pressure control system and/or a temperature control system to reduce a pressure within the vacuum chamber to the determined operation pressure and/or to reduce a temperature within the vacuum chamber to the determined operation temperature.

In an example embodiment, each lateral face of the four or more lateral faces of the vacuum chamber includes an opening, and the environmental control chamber device includes four or more doors, each door connected to a respective one of the four or more lateral faces and corresponding to the opening of the respective lateral face. In an example embodiment, the vacuum chamber is defined by six lateral faces, an upper face, and a lower face, each lateral face of the six lateral faces includes an opening, and the environmental control chamber device includes six doors, each door connected to a respective one of the six lateral faces and corresponding to the opening of the respective lateral face.

In an example embodiment, the at least one door is moveable (e.g., rotatable, slidable, and/or the like) between an open state and a closed state. The at least one door is configured to maintain the determined operation pressure and the determined operation temperature within the vacuum chamber when positioned in a closed state and is configured to enable access into the vacuum chamber when positioned in an open state. In an example embodiment, the at least one door includes a peripherally-lined seal that is configured to maintain the determined operation pressure within the vacuum chamber. In an example embodiment, the at least one door includes one or more radiation shields that are configured to maintain the determined operation temperature within the vacuum chamber and/or to reduce stray electrical and/or magnetic fields within the vacuum chamber. In an example embodiment, the at least one door includes two or more radiation shields that are nested and/or layered radiation shields.

In an example embodiment, the at least one opening is configured to be smaller than a respective lateral face. The at least one opening is further configured such that an area of the at least one opening is maximized, and the at least one door is dimensioned based at least in part on the dimensions of the at least one opening. In an example embodiment, the at least one opening is dimensioned based at least in part on a payload to be stored, disposed, positioned, operated, and/or used to perform one or more actions in the vacuum chamber. In an example embodiment, the upper face includes one or more access ports, the one or more access ports configured to enable access to an interior volume of the vacuum chamber by at least one of (i) electrical wires, (ii) optical fibers and/or beam paths, (iii) fluid lines, (iv) an optical imaging device, or (v) mechanical feedthroughs. In an example embodiment, the at least one door and/or at least one of the four or more lateral faces includes one or more access ports. In an example embodiment, the one or more access ports are configured to enable access to an interior volume of the vacuum chamber by at least one of (i) electrical wires, (ii) optical fibers and/or beam paths, (iii) fluid lines, (iv) an optical imaging device, or (v) mechanical feedthroughs. In an example embodiment, the one or more access ports are transparent at a wavelength or wavelength range of interest of an optical imaging device positioned exterior to the vacuum chamber. In an example embodiment, causing the interior volume of the vacuum chamber to have the determined operation pressure and the determined operation temperature is based at least in part on determining that the at least one door is positioned in a closed state based at least in part on a signal generated by a door sensor associated with the at least one door.

According to yet another aspect, a computer program product is provided that includes at least one non-transitory computer-readable storage medium having computer-executable program code instructions stored therein. The computer-executable program code instructions include program code instructions configured to, when executed by a processor of an apparatus, cause the apparatus to open at least one door of an environmental control chamber device. The at least one door is connected to a respective one of four or more lateral faces defining a vacuum chamber of the environmental control chamber device. The computer program product further causes the apparatus to, after a payload has been inserted into an interior volume of the vacuum chamber and/or has been accessed through at least one opening of the four or more lateral faces corresponding to the at least one door, determine that the at least one door is closed. The computer program product further causes the apparatus to determine an operation pressure and an operation temperature for the vacuum chamber, and to cause the vacuum chamber to have the determined operation pressure and the determined operation temperature.

In an example embodiment, the determined operation pressure is a vacuum pressure (e.g., less than 14.7 psi) and the determined operation temperature is a cryogenic temperature (e.g., less than 124 K). In an example embodiment, a controller of the environmental control chamber device causes a pressure control system and/or a temperature control system to reduce a pressure within the vacuum chamber to the determined operation pressure and/or to reduce a temperature within the vacuum chamber to the determined operation temperature. In an example embodiment, each lateral face of the four or more lateral faces of the vacuum chamber includes an opening, and the environmental control chamber device includes four or more doors, each door connected to a respective one of the four or more lateral faces and corresponding to the opening of the respective lateral face. In an example embodiment, the vacuum chamber is defined by six lateral faces, an upper face, and a lower face, each lateral face of the six lateral faces includes an opening, and the environmental control chamber device includes six doors, each door connected to a respective one of the six lateral faces and corresponding to the opening of the respective lateral face.

In an example embodiment, the at least one door is moveable (e.g., rotatable, slidable, and/or the like) between an open state and a closed state. The at least one door is configured to maintain the determined operation pressure and the determined operation temperature within the vacuum chamber when positioned in a closed state and is configured to enable access into the vacuum chamber when positioned in an open state. In an example embodiment, the at least one door includes a peripherally-lined seal that is configured to maintain the determined operation pressure within the vacuum chamber. In an example embodiment, the at least one door includes one or more radiation shields that are configured to maintain the determined operation temperature within the vacuum chamber and/or to reduce stray electrical and/or magnetic fields within the vacuum chamber. In an example embodiment, the at least one door includes two or more radiation shields that are nested and/or layered radiation shields.

In an example embodiment, the at least one opening is configured to be smaller than a respective lateral face. The at least one opening is further configured such that an area of the at least one opening is maximized, and the at least one door is dimensioned based at least in part on the dimensions of the at least one opening. In an example embodiment, the at least one opening is dimensioned based at least in part on a payload to be stored, disposed, positioned, operated, and/or used to perform one or more actions in the vacuum chamber. In an example embodiment, the upper face includes one or more access ports, the one or more access ports configured to enable access to an interior volume of the vacuum chamber by at least one of (i) electrical wires, (ii) optical fibers and/or beam paths, (iii) fluid lines, (iv) an optical imaging device, or (v) mechanical feedthroughs. In an example embodiment, the at least one door and/or at least one of the four or more lateral faces includes one or more access ports. In an example embodiment, the one or more access ports are configured to enable access to an interior volume of the vacuum chamber by at least one of (i) electrical wires, (ii) optical fibers and/or beam paths, (iii) fluid lines, (iv) an optical imaging device, or (v) mechanical feedthroughs. In an example embodiment, the one or more access ports are transparent at a wavelength or wavelength range of interest of an optical imaging device positioned outside the vacuum chamber. In an example embodiment, causing the interior volume of the vacuum chamber to have the determined operation pressure and the determined operation temperature is based at least in part on determining that the at least one door is positioned in a closed state based at least in part on a signal generated by a door sensor associated with the at least one door.

### BRIEF DESCRIPTION OF THE DRAWINGS

Having thus described the invention in general terms, reference will now be made to the accompanying drawings, which are not necessarily drawn to scale, and wherein:

FIG. 1 provides an overview of an example system, in accordance with an example embodiment.

FIG. 2 provides a block diagram of an environmental control chamber device, in accordance with an example embodiment.

FIG. 3 provides a block diagram of a controller of an environmental control chamber device, in accordance with an example embodiment.

FIG. 4 provides a perspective view of an environmental control chamber device, in accordance with an example embodiment.

FIG. 5 provides another perspective view of an environmental control chamber device, in accordance with an example embodiment.

FIG. 6 provides a cross-section view of an environmental control chamber device, in accordance with an example embodiment.

FIG. 7 provides a front view of a door of an environmental control chamber device, in accordance with an example embodiment.

FIG. 8 provides a block diagram of a computing entity, in accordance with an example embodiment.

FIG. 9 provides a diagram of a process flow of operating an environmental control chamber device, in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within engineering and/or manufacturing limits and/or within user measurement capabilities, unless otherwise indicated. Like numbers refer to like elements throughout.

### Example Environmental System

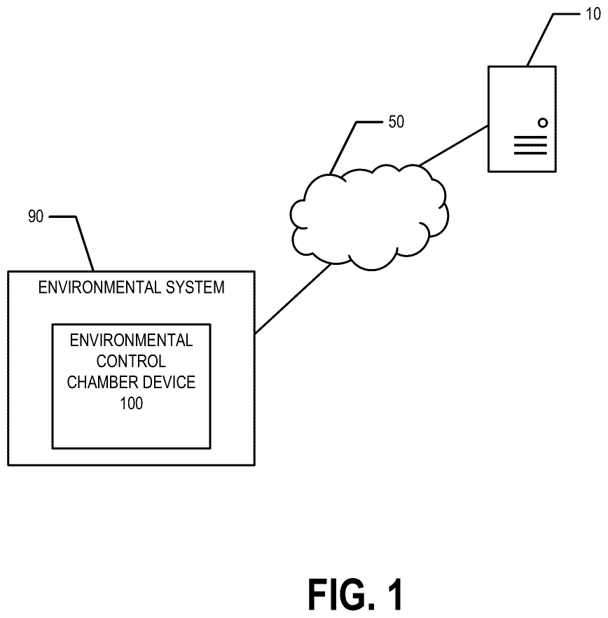

FIG. 1 provides an overview of an example system, in accordance with an example embodiment. In various example embodiments, the example system comprises a computing entity 10, a network 50, and an environmental system 90. The environmental system 90 comprises an environmental control chamber device 100. In various example embodiments, the computing entity 10 may be configured to communicate, via the network 50, with the environmental system 90. In various example embodiments, the computing entity 10 may be configured to communicate, via the network 50 and/or via the environmental system 90, with the environmental control chamber device 100. For example, the computing entity 10 may be configured to operate, or cause various operations to be performed on and/or by the environmental control chamber device 100. The computing entity 10 may be embodied by or associated with a variety of computing devices including, for example, a computer, server, server system, a personal computer, a computer workstation, a laptop computer, a plurality of networked computing devices, a mobile computing device, a cellular telephone, a personal digital assistant (PDA), and/or the like. The network 50 may be configured to enable communication between the computing entity 10 and the environmental control chamber device 100. The network 50 may be a wired or wireless network. In an example embodiment, the computing entity 10 is in direct wired and/or wireless communication with the environmental control chamber device 100.

In various example embodiments, the environmental control chamber device 100 is configured to have a payload disposed within a vacuum chamber of the environmental control chamber device 100 and maintain the vacuum chamber at a particular pressure and a particular temperature (e.g., an operation temperature and operation temperature) while the payload is operated to perform one or more operations, functions, and/or actions. In various embodiments, the particular pressure is a vacuum pressure (e.g., less than 14.7 psi). In various embodiments, the particular temperature is a cryogenic temperature (e.g., between 0 K and 124 K). In various embodiments, the particular temperature is in a range of 1 mK to 500 K. For example, the particular pressure and the particular temperature may be configured to simulate conditions of expected operation for the payload (e.g., Earth-based system conditions, near Earth orbit or near other planetary or moon orbit conditions, interplanetary space conditions, inter-solar system space conditions, near sun (e.g., at a distance of less than 0.75 astronomical units from the sun) orbit conditions, and/or the like.

The environmental control chamber device 100 is configured to enable access to the payload disposed within the environmental control chamber device 100. For example, the environmental control chamber device 100 comprises at least one door. The at least one door is moveable (e.g., rotatable, slidable, and/or the like) between a closed state and an open state (and vice versa). For example, the at least one door is connected to the vacuum chamber via one or more hinges and is configured to rotate between a closed and an open state. The at least one door is configured to enable access to a payload disposed within the environmental control chamber device 100 when the at least one door is positioned in an open state. In various example embodiments, the environmental control chamber device 100 comprises a vacuum chamber, a controller, and the at least one door. In various example embodiments, the computing entity 10 may communicate (e.g., via the network 50) with the controller. In an example embodiment, more than one computing entity 10 may communicate (e.g., via the network 50) with the environmental control chamber device 100.

In various example embodiments, the environmental control chamber device 100 is used for system-level testing at vacuum pressures and particular temperatures (e.g., one or more selected temperatures from a range of 1 mk to 500 K, the particular temperatures selected based on the intended and/or expected operating conditions of the payload). For example, the environmental control chamber device 100 may be used for satellite testing in simulated space-like environments, where satellite systems may be disposed within the vacuum chamber at a vacuum pressure and a cryogenic temperature (e.g., a universe average temperature, near Earth temperature). As another example, operation of optical systems and/or optics for spaceborne and/or Earth-based applications at cryogenic temperatures may be tested using the environmental control chamber device 100. In various embodiments, the environmental control chamber device 100 is used for component-level testing at cryogenic temperatures and/or other selected temperatures in the range of 1 mK to 500 K. For example, various hardware components, electronics components, optics components, telecommunications components, and mechanical components may be individually tested for performance, functionality, resiliency, efficiency, and/or the like at cryogenic temperatures. For example, such components may be relevant for a satellite system operating at planetary orbit and/or universe average (e.g., a few mK corresponding to the cosmic microwave background) temperatures. Various embodiments provide various technical advantages in system-level and component-level testing, as the environmental control chamber device 100 enables modification of system parts and components in situ.

In addition to or alternative to system-level and/or component-level testing, the environmental control chamber device 100 may be configured to active cryogenic experiments, in various embodiments. The environmental control chamber device 100 may be used as a physics, component, and/or system testbed at temperatures on the scale of milli-Kelvins (mK) to approximately 400 Kelvin. For example, condensed matter physics experiments, astronomy experiments, quantum experiments, subscale testing for particle physics, material science experiments, magnetic sensing experiments, and/or the like may be performed and executed within the environmental control chamber device 100, or the vacuum chamber of the environmental control chamber device 100. As aforementioned, the environmental control chamber device 100 in various embodiments provides technical advantages by enabling improved access into the vacuum chamber, thereby enabling more control for various experiments and operations performed within the vacuum chamber. environmental control chamber

### Example Environmental Control Device Controller

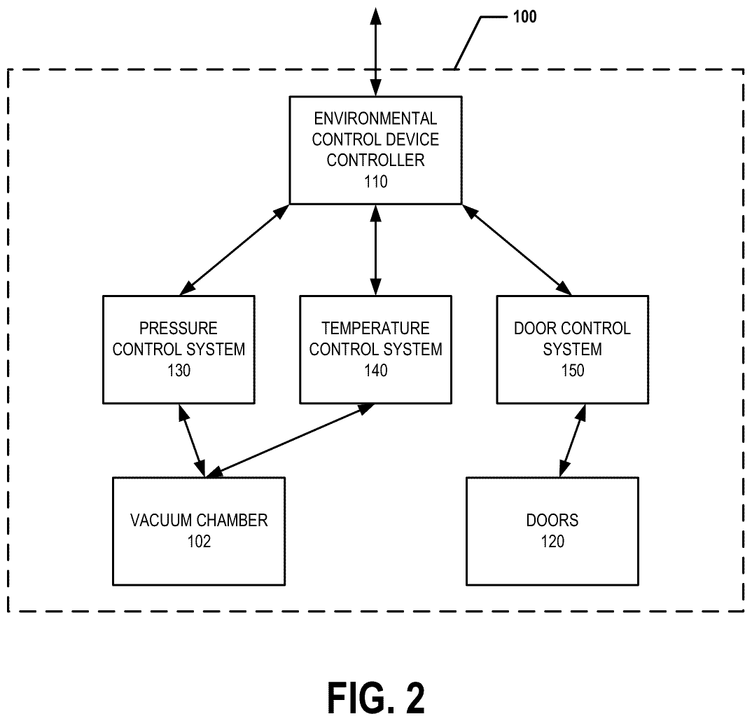

FIG. 2 provides a block diagram of various components of an environmental control chamber device 100. As previously described, the environmental control chamber device 100 comprises a vacuum chamber 102 for having a payload disposed therein and to maintain the payload and/or the interior volume of the vacuum chamber 102 at a particular and/or pre-determined pressure and temperature (e.g., an operation pressure and an operation temperature). The environmental control chamber device 100 further comprises an environmental control device controller 110, and at least one door 120. environmental control device controller 110 In an example embodiment, the environmental control device controller 110 communicates with computing entity 10. For example, the environmental control device controller 110 may be in communication with computing entity 10 via one or more wired or wireless networks 50 and receive information/data in the form of a computing language, executable instructions, command sets, and/or the like.

The environmental control device controller 110 may be in communication with one or more systems configured to operate the environmental control chamber device 100. For example, the environmental control chamber device 100 comprises one or more systems configured to control environmental conditions (e.g., pressure, temperature, humidity, and/or the like) within the vacuum chamber 102. As illustrated in FIG. 2, in an example embodiment, the environmental control chamber device 100 may comprise a pressure control system 130, a temperature control system 140, and a door control system 150. In various embodiments, the environmental control device controller 110 is in communication with each of the pressure control system 130, the temperature control system 140, and the door control system 150. It will be understood that embodiments of the present disclosure are not limited to the pressure control system 130, the temperature control system 140, and/or the door control system 150, and may comprise other systems configured to operate the environmental control chamber device 100 and perform other methods, operations, functions, and/or the like described herein. For example, example environmental control chamber devices 100 may comprise additional systems based on various actions to be performed on and/or by one or more respective payloads. A specific action (e.g., an experiment, controlled state evolution, function, and/or the like) may require additional systems, such as a fluid line control system, an electrical power supply system, an imaging system, and/or the like. Thus, it will be understood that the block diagram illustrated in FIG. 2 is non-limiting.

In an example embodiment, the environmental control device controller 110 may communicate with pressure control system 130, temperature control system 140, and/or door control system 150 via a wired or wireless network. The pressure control system 130, the temperature control system 140, and the door control system 150 may then perform operations on, be in communication with, be connected to, and/or the like, the vacuum chamber 102 and doors 120 of the environmental control chamber device 100. Likewise, in various embodiments, the pressure control system 130, the temperature control system 140, and the door control system 150 may be in communication with, be connected to, and/or the like, each other.

In various embodiments, the pressure control system 130 is configured to control a pressure within the vacuum chamber 102 of the environmental control chamber device 100. In various example embodiments, the pressure control system 130 is and/or comprises a vacuum system configured to maintain the vacuum chamber 102 at a particular vacuum pressure below 14.7 psi. For example, the pressure control system 130 comprises one or more vacuum pumps, ducts, tubes, pipes, vents, valves, seals, air reservoirs or tanks, and/or the like, connected to the vacuum chamber 102. The pressure control system 130 may be capable of evacuating air within the vacuum chamber 102 to lower the pressure within the vacuum chamber 102 and/or pump air into the vacuum chamber 102 to increase the pressure within the vacuum chamber 102. It will be appreciated that the pressure control system 130 may otherwise comprise any means (e.g., hardware and/or software) for at least determining a current pressure for the vacuum chamber 102 (e.g., via one or more pressure sensors disposed within the vacuum chamber 102 and/or the like), receiving an indication of a particular operation pressure for the vacuum chamber 102 (e.g., from the environmental control device controller 110), causing the vacuum chamber 102 to have the particular operation pressure, maintaining the vacuum chamber 102 at the particular operation pressure, and/or the like.

The temperature control system 140 may be configured to control a temperature within the vacuum chamber 102 of the environmental control chamber device 100. In various example embodiments, the temperature control system 140 is and/or comprises a cryogenic cooling system configured to maintain the vacuum chamber 102 at a particular cryogenic temperature between 0 K and approximately 124 K. In an example embodiment, the temperature control system 140 is configured to maintain the vacuum chamber 102 at a selected temperature within a range of 1 mK to 500 K. For example, the temperature control system 140 comprises evaporator coils, condenser coils, heating coils, compressors, fluid tanks or chambers (e.g., for liquid nitrogen, helium, hydrogen, and/or other temperature control fluid), fluid lines, pipes, valves, seals, and/or the like and may be capable of increasing or decreasing temperature within the vacuum chamber 102. It will be appreciated that the temperature control system 140 may otherwise comprise any means (e.g., hardware and/or software) for at least determining a current temperature within the vacuum chamber 102 (e.g., a thermometer and/or thermocouple disposed within the vacuum chamber and/or measuring the temperature of a temperature control fluid, such as liquid nitrogen, helium, hydrogen, and/or other temperature control fluids, exiting a cooling coil and/or the like of the environmental control chamber device 100), receiving an indication of a particular operation temperature for the vacuum chamber 102 (e.g., from the environmental control device controller 110), causing the vacuum chamber 102 to have the particular operation temperature, maintaining the vacuum chamber 102 at the particular operation temperature, and/or the like.

The door control system 150 may be configured to operate the at least one door 120 of the environmental control chamber device 100. For example, the door control system 150 may be configured to cause the at least one door 120 to move between an open and a closed state. In an example embodiment, the environmental control chamber device 100 comprises more than one door 120, and the door control system 150 is configured to operate each door 120 independently. In various example embodiments, the door control system 150 comprises hydraulics, motors, electric hinges, sensors, batteries, pulleys, wheels, gears, and/or the like, configured to enable movement of the doors 120. It will be appreciated that when a door 120 is referred to as being positioned in a closed state, the door 120 is planarly flush with a lateral face of the environmental control chamber device 100, and/or one or more hinges of the door 120 are positioned at 0 degrees relative to the environmental control chamber device 100. Likewise, the door 120 is referred to as being positioned in an open state when the door 120 is not planarly flush with a lateral face of the environmental control chamber device 100 and/or one or more hinges of the door 120 are positioned at greater than 0 degrees (e.g., 10 degrees to 180 degrees) relative to the environmental control chamber device 100. In various example embodiments, the door 120 is positioned in an open state when one or more hinges are positioned at an angle greater than an open state threshold angle. In various example embodiments, the door control system 150 comprises means (e.g., hardware and/or software) for at least determining a particular state for a door 120, receiving an indication of a particular state for a door 120 (e.g., from the environmental control device controller 110), causing a door 120 to be positioned in a particular state, and/or the like. The door control system 150 may also comprise means (e.g., hardware and/or software) for determining a present state of a door 120, such as via sensors. For example, the door control system 150 comprises and/or communicates with a door sensor that detects whether a door 120 is closed, determines an angle at which the door 120 is positioned, determines an amount of compression that a seal around a door 120 is experiencing, and/or the like. As another example, the door control system 150 comprises and/or communicates with one or more hinges that are configured to secure the door 120 in a closed state or unsecure the door 120 such that the door 120 is free to move to an open state.

In various example embodiments, each system (e.g., pressure control system 130, temperature control system 140, door control system 150, and/or the like) is configured to communicate with other systems. For example, the pressure control system 130 may be in communication with door control system 150 to determine whether the doors 120 are closed before causing the vacuum chamber 102 to have a particular operation pressure. For example, the door control system 150 may provide a signal to the environmental control device controller 110 indicating that the doors 120 are in the closed states, and then the environmental control device controller 110 (e.g., responsive to receiving and/or processing the signal) may control the pressure control system 130 and/or the temperature control system 140 to control the pressure and/or temperature within the vacuum chamber 102. In various example embodiments, the environmental control device controller 110 acts as a central entity in communication with the various systems (e.g., pressure control system 130, temperature control system 140, and/or door control system 150), and may accumulate data from each system while transmitting instructions to various systems for performing various operations.

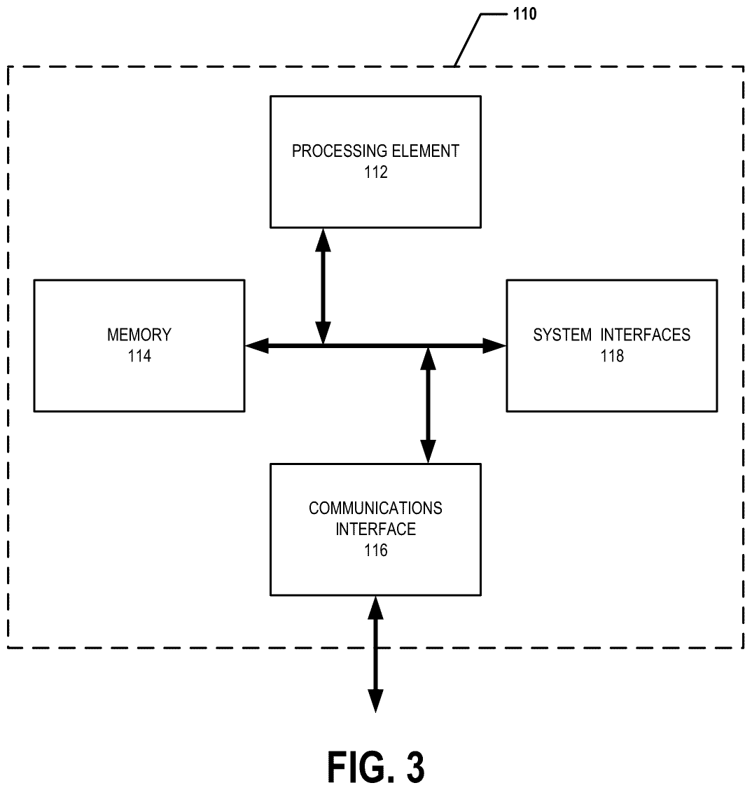

Referring now to FIG. 3, a block diagram of an example environmental control device controller 110 is provided. As illustrated, an environmental control device controller 110 may comprise a processing element 112, a memory 114, a communications interface 116, system interfaces 118, and/or other components configured to perform various operations, procedures, functions, and/or the like, described herein. As previously described, the environmental control device controller 110 is in communication with various systems (e.g., pressure control system 130, temperature control system 140, and/or door control system 150) of the environmental control chamber device 100, and is configured to transmit instructions to various systems for performing various operations via system interfaces 118 and/or communications interface 116. For example, an environmental control device controller 110 stores executable instructions in memory 114 that, when executed by processing element 112, cause the environmental control device controller 110 to determine a particular operation pressure and/or particular operation temperature for the vacuum chamber 102 and transmit (e.g., via system interfaces 118 and/or communications interface 116) an indication of the particular operation pressure to the pressure control system 130 and/or the particular operation temperature to the temperature control system 140. As another example, the environmental control device controller 110 may communicate with door control system 150 (e.g., via system interfaces 118) to cause a specific door 120 to be positioned in an open state, to cause a specific door 120 to be positioned in a closed state, to determine whether one or more doors 120 are in an open state or closed state, and/or the like, based on instructions received (e.g., via communications interface 116) from a computing entity 10.

In various example embodiments, the processing element 112 may comprise programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. For example, the memory 114 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various example embodiments, the system interfaces 118 may include one or more drivers and/or controller elements each configured to interface with the pressure control system 130, the temperature control system 140, and/or the door control system 150.

### Example Environmental Control Chamber Device

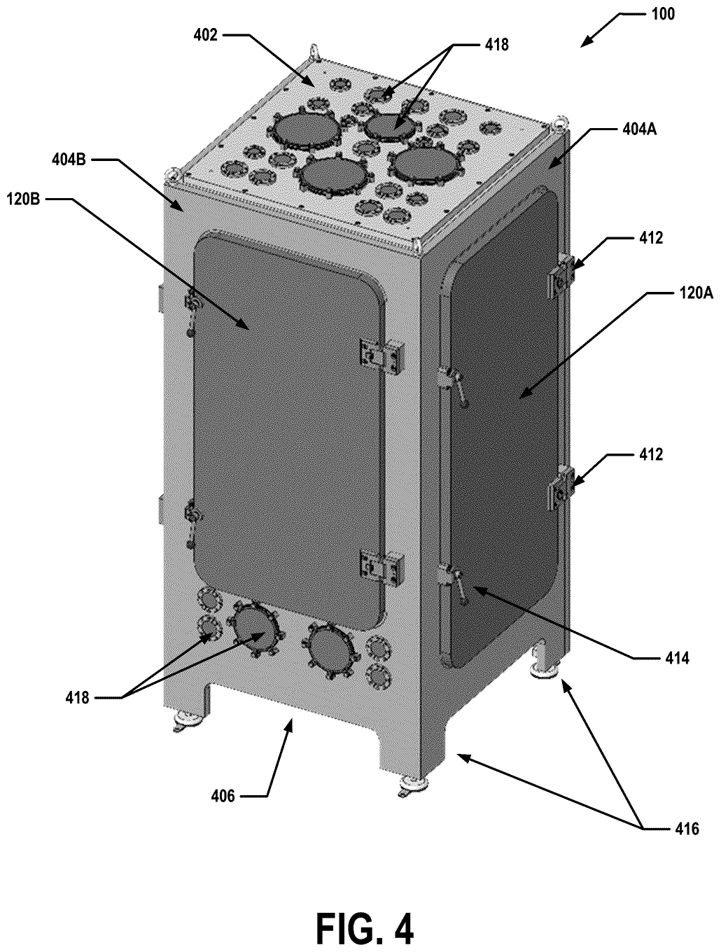

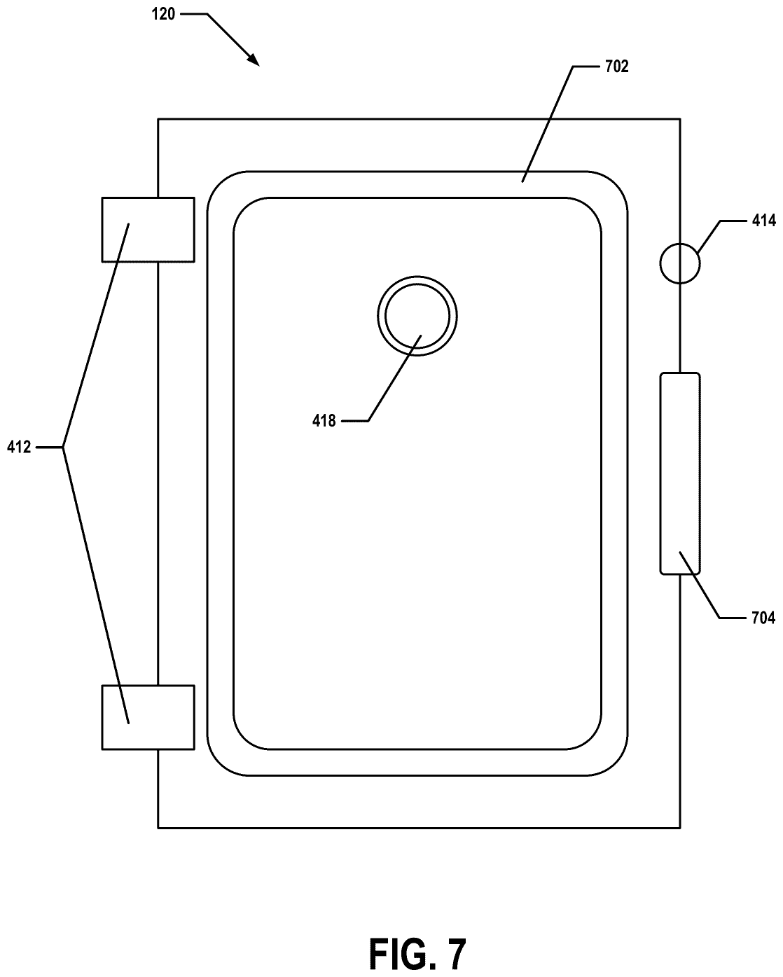

FIGS. 4-6 provide various views of an environmental control chamber device 100, and FIG. 7 provides a view of a door of an environmental control chamber device 100. Referring first to FIG. 4, a perspective view of an environmental control chamber device 100 is provided. The environmental control chamber device 100 comprises a vacuum chamber 102 comprising and/or defined by four or more lateral faces (e.g., 404A, 404B), an upper face 402, and a lower face 406 (not explicitly illustrated). Each of the four lateral faces 404 may be substantially rectangularly shaped. As such, the vacuum chamber 102 may be defined as a substantially rectangular prismatic shape. In various example embodiments, the vacuum chamber 102 is defined by more than four lateral faces 404 in addition to an upper face 402 and a lower face 406, such as in a substantially pentagonal prismatic shape, a substantially hexagonal prismatic shape, a substantially heptagonal prismatic shape, a substantially octagonal prismatic shape, and so on. The vacuum chamber 102 encloses and/or defines a three-dimensional volume and isolates the three-dimensional volume within an interior of the vacuum chamber 102 from an external environment. It will be appreciated that the vacuum chamber 102 is capable of maintaining a pressure and a temperature in the enclosed three-dimensional volume that are different than an external pressure and an external temperature of the external environment outside the vacuum chamber 102. In various example embodiments, the vacuum chamber 102 may comprise nested chambers. For example, the vacuum chamber 102 may comprise an outer chamber defined by four or more lateral faces 404, an upper face 402, and a lower face, and the vacuum chamber 102 may further comprise an inner chamber positioned within the outer chamber, with a gap (e.g., an air gap) between the inner and outer chambers.

The vacuum chamber 102 may be made of metal and/or metal alloys. For example, the vacuum chamber is composed of copper and/or copper alloys, in an example embodiment. In various embodiments, the vacuum chamber 102 and the doors are made of metal and/or metal alloys (e.g., stainless steel) based at least in part on desired vacuum properties, strength, and resilience of said metal and/or metal alloys. In various embodiments, the vacuum chamber 102 and the doors are made of metal and/or metal alloys (e.g., aluminum) based at least in part on desired strength-to-weight ratios of said metal and/or metal alloys. In various example embodiments, the vacuum chamber 102 may be composed of materials determined based on a payload to be stored, disposed, positioned, operated, and/or used to perform one or more actions in the vacuum chamber 102. In various example embodiments, the vacuum chamber 102 may be configured to have a payload disposed therein and enable various actions to be performed with and/or by the payload. For example, the vacuum chamber 102 may be dimensioned (e.g., configured to have a specific height, width, depth) based on the size of a payload to be disposed in the vacuum chamber 102. Additionally, one or more actions may be performed on and/or by the payload at a particular operation pressure and a particular operation temperature. In various example embodiments, the particular operation pressures are vacuum pressures (e.g., below 14.7 psi), and the particular operation temperatures are cryogenic temperatures (e.g., within the range of 0 K to 124 K). The actions may include performing an experiment, a controlled state evolution, a chemical reaction, performing a function, and/or the like.

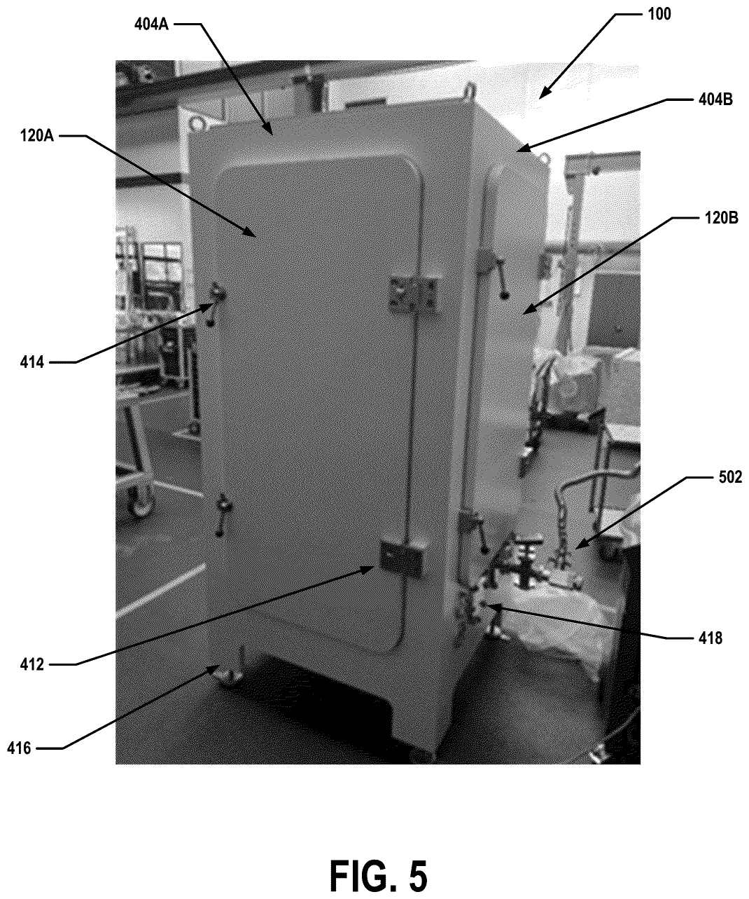

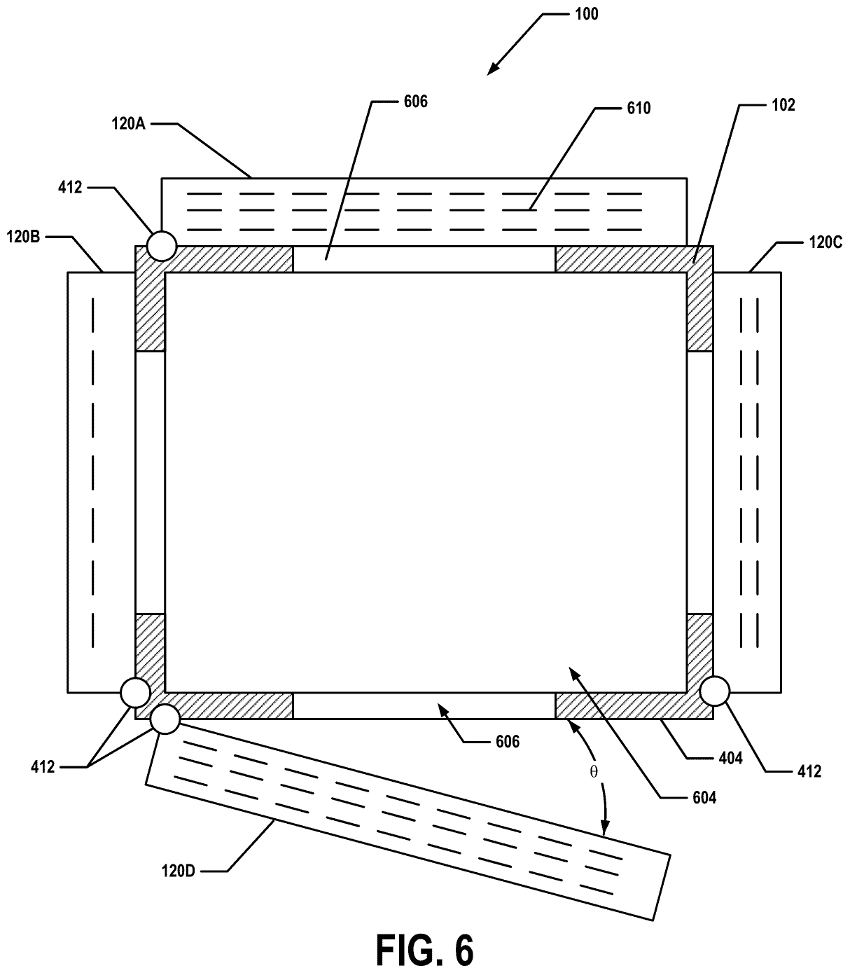

The four lateral faces 404 of the vacuum chamber 102 may comprise at least one opening. For example, the four lateral faces 404 may comprise four openings, each lateral face 404 comprising one opening. In another example, only one lateral face 404 comprises an opening. In an example embodiment, a lateral face 404 comprises more than one opening. The environmental control chamber device 100 comprises doors 120 that correspond to the openings of the four lateral faces 404. For example, FIG. 4 illustrates the environmental control chamber device 100 comprising two doors 120A, 120B each positioned and connected to a respective lateral face 404 (door 120A connected to lateral face 404A, and door 120B connected to lateral face 404B). It will be appreciated that each door 120 may correspond to one opening of the four lateral faces. In an example embodiment, a lateral face 404 may comprise two openings, and therefore, two doors 120 may be connected to the same lateral face 404. Each door 120 may be configured to seal an opening of a respective lateral face 404. For example, lateral face 404A comprises an opening, and door 120 is positioned to seal the opening when in a closed state (as illustrated in FIGS. 5 and 6). As such, an enclosed three-dimensional volume within the vacuum chamber 102 is fully defined when the doors 120 are positioned in a closed state and seal openings in the lateral faces 404 of the vacuum chamber 102. In various embodiments, the doors 120 may seal the openings against air flow, heat flow, magnetic flow and/or the like between the enclosed three dimensional volume within the vacuum chamber 102 and the environment external to the vacuum chamber 102.

In various example embodiments, each door 120 is configured to move between a closed state and an open state while remaining connected to a respective lateral face 404. For example, the environmental control chamber device 100 comprises hinges 412 connecting a door 120 to a lateral face 404 and allowing a door 120 to swing and/or rotate between a closed and an open state. In various example embodiments, hinges 412 may be motorized hinges, electric hinges, and/or the like such that movement of a door 120 may be controlled, such as by a door control system 150, an environmental control device controller 110, a computing entity 10, and/or the like. Hinges 412 may also be configured to allow a human operator to manually move a door 120 between a closed and an open state. It will be appreciated that other door control mechanisms other than hinges 412 may also be implemented. For example, in an example embodiment, hydraulic pistons or arms are configured to rotate, slide, move, and/or translate the door 120 between a closed state and an open state.

The environmental control chamber device 100 may further comprise latches 414. Latches 414 may be configured to secure a door 120 in a closed state to seal the vacuum chamber 102. For example, a door 120 cannot be opened when latches 414 are activated or otherwise securing the door 120. It will be appreciated that latches 414 may be implemented with any type of mechanical, electrical or other form of locking, securing, and/or fastening mechanisms. For example, latches 414 are controllable (e.g., by door control system 150, environmental control device controller 110) to secure and unsecure a door 120. Likewise, latches 414 may be configured to provide a signal (e.g., to door control system 150, environmental control device controller 110) that a door 120 is secured or unsecured.

In various example embodiments, the environmental control chamber device 100 comprises legs 416. Legs 416 may be configured to stabilize the environmental control chamber device 100. Legs 416 may be advantageous in allowing a lower face 406 of the vacuum chamber 102 to be positioned at a height above the ground, enabling various operations to be performed on the lower face such as attaching devices to the lower face, accessing an interior volume of the vacuum chamber 102 via the lower face, and/or the like. In various example embodiments, legs 416 may comprise wheels or any other movement mechanism to easily allow transport or movement of the environmental control chamber device 100, such as in a lab space. Legs 416 may be defined, shaped, dimensioned, and/or the like to provide stability for the environmental control chamber device 100 and/or defined, shaped, dimensioned, and/or the like based on a weight of the environmental control chamber device 100 and a payload to be disposed within the environmental control chamber device 100.

The environmental control chamber device 100 may further comprise access ports 418. As illustrated, access ports 418 may be positioned on the upper face 402 of the vacuum chamber 102, and/or on one or more lateral faces 404 (e.g., 404B) of the vacuum chamber 102. In various example embodiments, access ports 418 may also be positioned on a lower face 406 of the vacuum chamber 102, and the legs 416 may have a height allowing access ports 418 to be positioned on the lower face of the vacuum chamber 102. In various example embodiments, access ports may also be positioned on a door 120. In various example embodiments, access ports 418 are configured to enable access into an interior volume of the vacuum chamber 102.

FIG. 5 illustrates an environmental control chamber device 100 comprising a vacuum chamber 102 defined by four lateral faces 404, and upper face 402, and a lower face 406, and at least two doors 120A, 120B connected to lateral faces 404A, 404B via hinges 412 and secured via latches 414. It may be appreciated that the environmental control chamber device 100 may further comprises at least two more doors 120 connected to the lateral faces opposite to lateral faces 404A, 404B and not explicitly shown due to the perspective view of the environmental control chamber device 100. The environmental control chamber device 100 further comprises access ports 418 enabling access into an interior volume of the vacuum chamber 102. The environmental control chamber device 100 comprises access ports 418 positioned on lateral face 404B below door 120B. In various example embodiments, access ports 418 may also be positioned anywhere on a lateral face 404 not connected to a door 120.

FIG. 5 also illustrates a fluid line 502 connected to an access port 418 accessing an interior volume of the vacuum chamber 102. Fluid lines 502 may be components of various systems of the environmental control chamber device 100, such as the pressure control system 130 and/or the temperature control system 140. For example, fluid lines 502 of the pressure control system 130 may deliver air to and/or draw air from an interior volume of the vacuum chamber 102 to control and maintain a particular vacuum pressure. For example, fluid lines 502 of the temperature control system 140 may deliver a temperature control fluid (e.g., liquid nitrogen, helium, hydrogen, and/or other temperature control fluid) to cryogenic coils positioned in the interior volume of the vacuum chamber 102 to control and maintain a particular cryogenic temperature. For example, fluid line 502 may be and/or may be a component of a cooling device (e.g., a cryocooler). Fluid lines 502 may also be components of other systems configured to perform various actions on a payload disposed within the vacuum chamber 102, or configured to enable a payload disposed within the vacuum chamber 102 to perform various actions. For example, an action may be a reaction, and a fluid line 502 may introduce a reactive gas into the vacuum chamber 102. In another example, the fluid line 502 may deliver and/or cycle an inert gas (e.g., helium, neon, argon, krypton, xenon, radon, and/or the like) through the volume enclosed by the vacuum chamber 102 while an action, such as a reaction, is performed.

In the illustrated embodiment, the fluid line 502 comprises a valve. In various example embodiments, access ports 418 may comprise a valve and/or any other means of controlling, adjusting, manipulating, and/or the like, an amount of access into the interior volume of the vacuum chamber 102. Access ports 418 may comprise peripherally-lined seals, such that a pressure and a temperature within the vacuum chamber 102 is maintained while a fluid line 502 is connected. For example, U.S. application Ser. No. 17/248,748, filed Feb. 5, 2021, discloses an example fluid connector that may be used to provide access to the volume and/or one or more components disposed within the volume (e.g., cooling coils, etc.) enclosed by a vacuum chamber 102, the content of which is hereby incorporated by reference in its entirety.

Access ports 418 may be configured to enable access to the interior volume of the vacuum chamber 102 by means other than fluid lines 502. In various example embodiments, access ports 418 enable access into the vacuum chamber 102 by electrical lines. For example, electrical lines originating from an electrical source (e.g., voltage source, signal generator, voltage-controlled oscillator, and/or the like) external to the vacuum chamber 102 may be connected to a payload disposed within the interior volume of the vacuum chamber 102 via access ports 418. Various actions (e.g., experiments, controlled state evolutions, reactions, functions performances, and/or the like) may be carried out on and/or by a payload in the vacuum chamber 102, and such actions may require electrical current, voltage, and/or signals to be supplied to the payload.

In various example embodiments, access ports 418 are configured to enable access to the interior volume of the vacuum chamber 102 by optical fibers and/or optical beam paths originating externally from the vacuum chamber 102. For example, optical fibers and/or optical beam paths may be used to cause a reaction in various physics related experiments and/or observe systems and components during testing. As such, access ports 418 may be configured to enable access by optical fibers and/or optical beam paths to the interior volume of the vacuum chamber 102. In various example embodiments, access ports 418 may be configured to otherwise enable access by laser beams to the interior volume of the vacuum chamber 102 and/or enable access by emitted signals from a payload to an exterior of the chamber. For example, access ports 418 may comprise a translucent and/or transparent window (e.g., at a wavelength and/or wavelength range of interest) through which laser beams may impact a payload within the vacuum chamber 102 and/or through which light emitted by the payload may exit the vacuum chamber 102 to be collected via various optics and/or optical detectors. As previously mentioned, access ports 418 may comprise peripherally-lined seals configured to maintain a pressure and a temperature within the vacuum chamber 102 while electrical wires and/or optical fibers are connected.

In various example embodiments, access ports 418 is configured to enable access by optical imaging devices and/or photodetectors (e.g., photodiodes, photomultiplier tubes, charge-coupled device (CCD) sensors, complimentary metal-oxide-semiconductor (CMOS) sensors, and/or the like) to the interior volume of the vacuum chamber 102. The optical imaging devices and/or photodetectors may be positioned exterior to the vacuum chamber 102. In an example embodiment, one or more access ports 418 are windows, enabling an optical imaging device to image at least a portion of a payload disposed within the interior volume of the vacuum chamber 102 and/or enabling a human operator to visually observe the payload. In various example embodiments, the access ports 418 comprises a cover or window that is transparent at a wavelength and/or wavelength range of interest through which an optical imaging device and/or photodetector may observe a payload disposed within the vacuum chamber 102. In various example embodiments, access ports 418 comprise means (e.g., attachment means and/or mounting components for mounting and/or securing an optical imaging device in relationship with a respective access port 418) for enabling access (e.g., observing, imaging, and/or the like) by an optical imaging device to the interior volume of the vacuum chamber 102. In various example embodiments, access ports 418 may be configured to connect to an optical imaging device, and may comprise peripherally-lined seals to maintain a pressure and a temperature within the vacuum chamber 102 while an optical imaging device is connected.

Thus, in general, access ports 418 may be configured to enable access by general instrumentation or sensing devices to the interior volume of the vacuum chamber 102. In various embodiments, access ports 418 may be configured to enable access by mechanical feedthroughs to the interior volume of the vacuum chamber 102. For example, mechanical feedthroughs may be configured to move (e.g., rotationally, laterally) a payload disposed within the vacuum chamber 102. For example, a mechanical feedthrough may comprise an axle connected to a payload disposed within the vacuum chamber 102 at one axle end and connected to a motor at the other axle end. For example, a mechanical feedthrough may comprise an axle connected to a payload disposed within the vacuum chamber 102 and configured to push and/or pull the payload.

Referring now to FIG. 6, a cross-section of an environmental control chamber device 100 is provided. The illustrated cross-section may be understood as a cross-section in the horizontal plane, or a transverse plane of the environmental control chamber device 100. As illustrated, the vacuum chamber 102 has a rectangular cross-section, and it follows that the vacuum chamber 102 may be defined by four lateral faces 404. As previously described, the vacuum chamber 102 may be defined by more than four lateral faces 404, thereby resulting in a pentagonal cross-section, a hexagonal cross-section, a heptagonal cross-section, an octagonal cross-section, or so on, in various other example embodiments. The environmental control chamber device 100 comprises four doors 120A, 120B, 120C, 120D, each connected to a respective lateral face of the four lateral faces 404 defining the vacuum chamber 102. The doors 120A-D are connected to the vacuum chamber 102 via hinges 412; however, it will be understood that other connection means allowing movement of the doors 120A-D between a closed and an open state may be used.

The illustrated environmental control chamber device 100 of FIG. 6 further comprises four openings 606; that is, the four lateral faces 404 defining the vacuum chamber 102 comprise four openings 606. More specifically, each lateral face 404 comprises one opening 606, although in some embodiments, each lateral face 404 is not limited to only one opening 606. Furthermore, in various other embodiments, some lateral faces 404 may not have an opening 606. It will be understood that each opening 606 is configured to allow access into the interior volume 604 of the vacuum chamber 102. As illustrated, each opening 606 may extend through a lateral face thickness of the vacuum chamber 102. For example, each opening 606 may be a through hole through a lateral face of the vacuum chamber 102.

Openings 606 may be dimensioned based on a number of factors. In various example embodiments, openings 606 may be dimensioned relative to the dimensions of a respective lateral face 404. For example, an opening 606 is configured to be smaller than the lateral face 404 through which the opening 606 extends. Returning to the perspective views illustrated in FIGS. 5 and 6, each lateral face 404 may be substantially rectangularly shaped and therefore has a height dimension and a width dimension. Thus, an opening 606 has a height dimension that is less than the height dimension of the respective lateral face 404, and a width dimension that is less than the width dimension of the respective lateral face 404. In an example embodiment, the height dimension of the opening 606 is smaller than the height dimension of the respective lateral face 404 and/or the width dimension of opening 606 is smaller than the width dimension of the respective lateral face 404 by an amount required to maintain the structural integrity, strength, and/or the like of the vacuum chamber 102.

In an example embodiment, the height dimension of the opening 606 is smaller than the height dimension of the respective lateral face 404 and/or the width dimension of opening 606 is smaller than the width dimension of the respective lateral face 404 by an amount such that the area of the opening 606 is maximized. In the illustrated embodiment in FIG. 6, the opening 606 in the lateral face 404 associated with door 120D has a width dimension spanning about half of the width dimension of the lateral face 404, although such a ratio is purely illustrative and non-limiting. For example, the opening 606 may be dimensioned to leave enough material in each lateral face 404 to provide structural integrity (e.g., integrity at vacuum pressures and cryogenic temperature) and to provide enough area for attachment of doors 120 (e.g., via hinges 412). In various embodiments, one or more openings 606 may be dimensioned so as to allow room for one or more access ports 418 on one or more lateral faces 404.

In various example embodiments, at least one of the openings 606 is dimensioned based at least in part on a payload to be disposed within the three-dimensional volume of the interior volume 604 of the vacuum chamber 102. Because the openings 606 are configured to allow a payload to be inserted into the interior volume 604 of the vacuum chamber 102, the openings 606 have large enough dimensions relative to the payload to be inserted that the payload may be inserted into the interior volume 604 of the vacuum chamber 102 without damaging the payload. In various example embodiments, a payload may be inserted into the interior volume 604 of the vacuum chamber 102 by individual components and subsequently assembled within the interior volume 604 of the vacuum chamber 102. In such embodiments, the openings 606 have large enough dimensions relative to the individual components of the payload to be inserted. Doors 120 may be dimensioned based at least in part on the dimensions of a corresponding opening 606. Specifically, in various embodiments, the doors 120 are dimensioned such that, when positioned in a closed state, the doors 120 seal the opening 606, and the interior volume 604 of the vacuum chamber 102 is completely enclosed from the external environment.

As illustrated, doors 120 are connected (e.g., via hinges 412) to an exterior portion of the lateral faces defining the vacuum chamber 102. It will be appreciated that the doors 120A-D are connected to the exterior portions of the lateral faces to seal the openings 606 while the interior volume 604 of the vacuum chamber 102 is maintained at a vacuum pressure, or a particular pressure lower than the pressure of the external environment. In fact, it may be further appreciated that the sealing of the openings 606 by the doors 120 improves over time as the pressure differential between the interior volume 604 of the vacuum chamber 102 and the external environment generates an inward force on the doors 120.

In various embodiments, doors 120 comprise one or more radiation shields 610. In some embodiments, the one or more radiation shields 610 are made of metal and/or metal alloys, such as aluminum and/or copper. In various example embodiments, the one or more radiation shields 610 may be inserted within, attached to, and/or otherwise a part of doors 120. For example, doors 120 may be configured to have a thickness such that one or more radiation shields 610 may be placed within the doors 120. As illustrated, each door 120 may comprise a different number of radiation shields 610; however, in an example embodiment, each door 120 comprises the same number of radiation shields 610. In various embodiments, one or more doors each comprise two or more radiation shields 610 that are nested and/or layered within the respective door 120. For example, doors 120A and 120D comprise three nested and/or layered radiation shields 610, while door 120B comprises one radiation shield 610. Radiation shields 610 are configured to maintain a temperature, such as a cryogenic temperature, in the interior volume 604 of the vacuum chamber 102 different than the temperature of the external environment. For example, radiation shields 610 may prevent external heat from radiating into the interior volume 604 of the vacuum chamber 102. In various example embodiments, the one or more radiation shields 610 may be and/or may comprise one or more magnetic shields configured to cause a magnetic field within the vacuum chamber 102 to have very few and/or very small fluctuations such that the magnetic field within the vacuum chamber 102 is highly uniform and/or homogenous. For example, the radiation shields 610 are configured to reduce stray electric and/or magnetic fields within the interior volume 604 of the vacuum chamber 102, in various embodiments.

Doors 120 are configured to hinge outwardly from the vacuum chamber 102. For example, door 120D is illustrated as being hinged at an outward angle θ of approximately 30° from the lateral face of the vacuum chamber 102. In various example embodiments, door 120D as illustrated (e.g., at θ≈30°) may be considered to be positioned in an open state. For example, with door 120D being positioned at approximately 30° from the lateral face 404 of the vacuum chamber 102, the interior volume 604 of the vacuum chamber 102 may be accessed via the opening 606. In various example embodiments, door 120D may be considered to be positioned in an open state when the angle θ is greater than a pre-determined open state threshold angle. For example, door 120D may be considered to be positioned in a closed state until the angle θ of door 120D with the lateral face is greater than the pre-determined open state threshold angle (e.g., 45°, 60°, 90°, 115°). The open state threshold angle may be determined based on a payload to be inserted via an opening 606 and/or disposed within the interior volume 604 of the vacuum chamber 102. For example, a particularly large payload may not be able to be inserted via opening 606 until the door 120D is at least at a 90° angle with the lateral face 404 of the vacuum chamber 102. In an example embodiment, the door 120D is considered in an open state when the angle θ is greater than 0° and/or when a respective latch and/or locking mechanism is unsecured (e.g., not maintaining the door in a closed state).

The environmental control chamber device 100, or the doors 120, may comprise one or more door sensors configured to determine a closed or an open state of the doors 120. The one or more door sensors may be part of, connected to, and/or in communication (e.g., via a wired or wireless network) with door control system 150, environmental control device controller 110, and/or computing entity 10. In FIG. 7, a door 120 is illustrated and comprises a door sensor 704. The door sensor 704 may be positioned at any location on a door 120 where the door sensor 704 may accurately and precisely determine a closed or an open state of the doors 120. As illustrated, the door sensor 704 is positioned on a side of the door 120 opposite the hinges 412. In another embodiment, the door sensor 704 is positioned on a side of the door 120 with the hinges 412. The door sensor 704 may be disposed on a surface of the respective lateral face 404 (e.g., about the edge of the respective opening 606). In an example embodiment, the door sensor 704 comprises a sensor portion secured to the door 120 and an associated sensor positioned on the lateral face 404 to which the door 120 is connected, in order to determine an angle of the door 120 with the lateral face 404. In an example embodiment, the door sensor 704 is disposed in and/or integrated with the peripherally-lined seal 702 secured to the door 120 and/or on the respective lateral face 404 about the opening 606. In various example embodiments, the hinges 412 may comprise the door sensor 704, such that the door sensor 704 may determine an angle of the door 120 with the lateral face 404. For example, a door sensor 704 that is a part of, connected to, or in communication with hinges 412 may determine an angle through which the door 120 has moved through, or an angle over time (e.g., an angular velocity). In various example embodiments, the latch 414 may comprise the door sensor 704, such that the door sensor 704 may determine whether the door 120 is latched or is not latched. In various example embodiments, the door sensor 704 is capable of determining an amount of compression experienced by a peripherally-lined seal 702 of the door 120. In an example embodiment, the state (e.g., open or closed) of the door 120 is determined based on an amount of compression experienced by a peripherally-lined seal 702 (e.g., determined by the door sensor 704) relative to a threshold compression value. It will be appreciated that the environmental control chamber device 100, door 120, hinges 412, peripherally-lined seal 702, and/or latches 414 comprise at least one door sensor 704 configured to determine a state of a respective door 120 (e.g., a closed state or an open state of the respective door 120).

In various example embodiments, a door 120 comprises one or more access ports 418. As previously mentioned, access ports 418 may be configured to enable access to the interior volume 702 of the vacuum chamber 102, such as by electrical wires, optical fibers, optical beam paths, fluid lines, optical imaging devices, mechanical feedthroughs, and/or the like. Thus, a door 120 positioned in a closed state and thereby sealing an opening 606 into the interior volume 604 of the vacuum chamber 102, may still enable access into the interior volume 604 of the vacuum chamber 102 via one or more access ports 418.

A door 120 further comprises a peripherally-lined seal 702, in various embodiments. The peripherally-lined seal 702 is configured to physically seal a corresponding opening 606 in a lateral face 404 to which the door 120 is connected. For example, the peripherally-lined seal 702 may be a rubber seal, a silicone seal, a polyurethane seal, and/or the like, configured to create and/or reinforce an isolated environment in the interior volume 604 of the vacuum chamber 102 when the door 120 is positioned in a closed state over a corresponding opening 606. For example, due at least in part to the peripherally-lined seal 702, the interior volume 604 of the vacuum chamber 102 may maintain a vacuum pressure and a cryogenic temperature different than the pressure and the temperature of the external environment. In various example embodiments, the peripherally-lined seal 702 is shaped and dimensioned according the shape and dimension of the corresponding opening 606. In the illustrated embodiment, the peripherally-lined seal 702 is substantially rectangularly shaped and may correspond to an opening 606 that is similarly substantially rectangularly shaped. In an example embodiment, at least a portion of the peripherally-lined seal 702 is disposed on the respective lateral face 404 about an edge and/or periphery of the respective opening 606.

The peripherally-lined seal 702 experiences an amount of compression when the door 120 is positioned against the respective lateral face 404. It may be appreciated that the amount of compression experienced by the peripherally-lined seal 702 increases over time as a pressure differential between the interior volume 604 of the vacuum chamber 102 and the external environmental increases. In various example embodiments, the amount of compression experienced by the peripherally-lined seal 702 may be detected by the door sensor 704. In an example embodiment, the amount of compression experienced by the peripherally-lined seal 702 is compared to a pre-determined threshold compression value to determine the state (e.g., open or closed) of the door 120. For example, the door 120 is determined to be in a closed state when the amount of compression experienced by the peripherally-lined seal 702 exceeds a pre-determined threshold compression value.

### Example Computing Entity

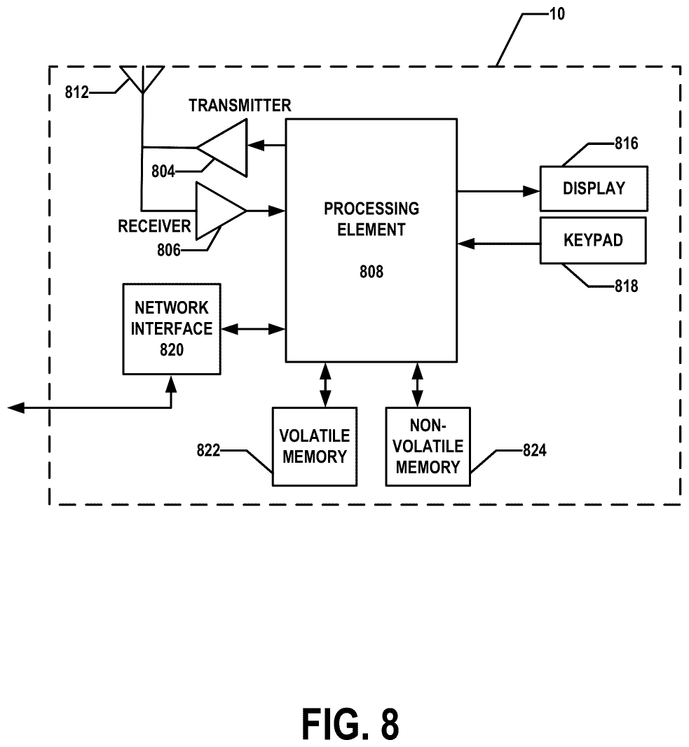

FIG. 8 provides an illustrative schematic representative of an example computing entity 10 that can be used in conjunction with embodiments of the present invention. In various embodiments, a computing entity 10 is configured to allow a user to provide input to the environmental control chamber device 100 (e.g., via a user interface of the computing entity 10) via a network 50. For example, the computing entity 10 may interface with the environmental control device controller 110 to control operation of the environmental control chamber device 100 and receive data from the environmental control chamber device 100. environmental control chamber

As shown in FIG. 8, a computing entity 10 can include an antenna 812, a transmitter 804 (e.g., radio), a receiver 806 (e.g., radio), and a processing element 808 that provides signals to and receives signals from the transmitter 804 and receiver 806, respectively. The signals provided to and received from the transmitter 804 and the receiver 806, respectively, may include signaling information/data in accordance with an air interface standard of applicable wireless systems to communicate with various entities, such as an environmental control device controller 110 other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

The computing entity 10 may also comprise a user interface device comprising one or more user input/output interfaces (e.g., a display 816 and/or speaker/speaker driver coupled to a processing element 808 and a touch screen, keyboard, mouse, and/or microphone coupled to a processing element 808). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 818 (hard or soft), a touch display, voice/speech or motion interfaces, scanners, readers, or other input device. In embodiments including a keypad 818, the keypad 818 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 822 and/or non-volatile storage or memory 824, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Example Operation

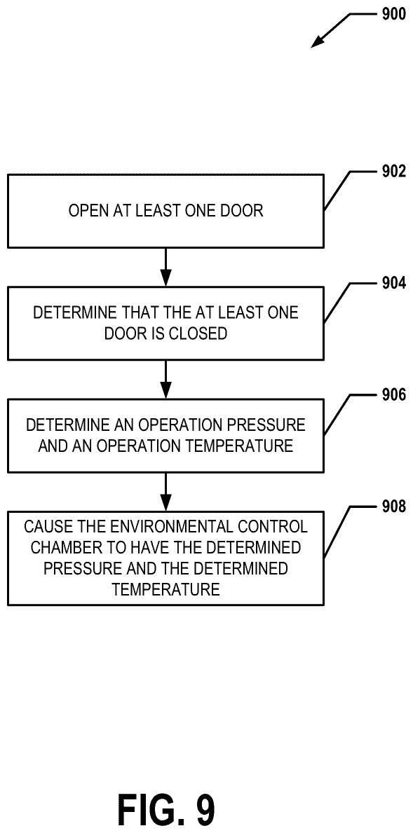

FIG. 9 provides a process flow 900 for operating an environmental control chamber device 100. In various example embodiments, the process flow 900 may be performed by a computing entity 10 and/or an environmental control device controller 110. In various example embodiments, the computing entity 10 and/or the environmental control device controller 110 comprise means for performing operations of process flow 900, such as a respective processing element 112, 808, memory 114, 822, 824 storing corresponding executable instructions, system interfaces 118, communication interface 116, 820, user interfaces 816, 818, and/or the like. For example, computing entity 10 comprises communication means for transmitting instructions for performing process flow 900 such that environmental control device controller 110 receives instructions for performing process flow 900.

Process flow 900 begins at operation 902, which comprises opening at least one door 120 of the environmental control chamber device 100. The at least one door 120 is connected to a respective one of four or more lateral faces 404 defining a vacuum chamber 102 of the environmental control chamber device 100. In various example embodiments, the computing entity 10 and/or environmental control device controller 110 comprise means, such as processing elements 808 and 112, memory 822, 824, and 114, communication interface 820 and 116, user interfaces 816 and 818, and/or the like, for opening at least one door 120 of the environmental control chamber device 100. In an example embodiment, the door 120 is opened responsive to user input. For example, computing entity 10 may receive an indication via a keypad 818 (e.g., from a user) of a specific door 120 to open, in an embodiment where the environmental control chamber device 100 may comprise more than one door 120. It will be appreciated that a subset of the at least one door 120 of the environmental control chamber device 100 may be opened while the remaining doors 120 are closed. For example, environmental control device controller 110 communicates via communication interface 116 with a door control system 150 to cause at least one door 120 to be opened. In various example embodiments, opening at least one door 120 comprises releasing a latch 414 and/or other locking mechanism configured to secure the at least one door 120 in a closed state. In an example embodiment, opening the at least one door 120 comprises positioning the at least one door 120 at a specific angle θ from the respective lateral face 404 to which the at least one door 120 is connected. In an example embodiment, opening at least one door 120 comprises determining that at least one door 120 is positioned in an open state (e.g., by a human operator). In an example embodiment, opening the at least one door 120 comprises providing an indication (e.g., to a human operator) that the at least one door 120 should be opened.

In various example embodiments, opening at least one door 120 is based on a current pressure and a current temperature of the interior volume 604 of the vacuum chamber 102. For example, the at least one door 120 is opened only when the current pressure and the current temperature of the interior volume 604 of the vacuum chamber 102 is similar to the pressure and the temperature of the external environment (e.g., a pressure of approximately one atmosphere and a temperature of approximately room temperature). As such, opening the at least one door 120 may be based on a received indication (e.g., from a pressure control system 130, a temperature control system 140, an environmental control device controller 110) that the current pressure and the current temperature are similar to a certain degree to the pressure and the temperature of the external environment.

Operation 904 may follow operation 902. Operation 904 comprises determining that the at least one door 120 is closed, after a payload has been inserted into an interior volume of the vacuum chamber or accessed within the vacuum chamber through at least one opening of the four or more lateral faces corresponding to the at least one door. For example, the payload may be a system for system-level testing, a component for component-level testing, materials for a physics-related experiment, and/or the like. For example, determining that the at least one door 120 is closed is based on receiving an indication that the payload has been inserted or accessed. In various example embodiments, the computing entity 10 and/or environmental control device controller 110 comprise means, such as processing elements 808 and 112, memory 822, 824, and 114, communication interface 820 and 116, user interfaces 816 and 818, and/or the like, for determining that the at least one door 120 is closed. For example, the computing entity 10 may receive via a network interface 820 an indication that the at least one door 120 is positioned in a closed state.

In an example embodiment, the payload is already disposed within the vacuum chamber 102, and a human and/or robotic technician may access the payload and/or other component disposed within the vacuum chamber 102 (e.g., to perform maintenance, modify the payload, prepare the payload and/or other component for performing one or more actions, setting up a physics-related experiment, and/or the like) while the at least one door 120 is in the open state through the respective opening(s) 604. In such an embodiment, the computing entity 10 may first receive an indication that the human and/or robotic technician has concluded accessing the payload, and then determine whether the at least one door 120 has been closed. For example, the computing entity 10 may determine that the at least one door 120 has not been closed and accordingly display and/or provide an alert. The computing entity 10 may continue displaying and/or providing the alert until the computing entity 10 has determined that the at least one door 120 is closed.

In various example embodiments, the environmental control device controller 110 communicates via system interfaces 118 with door control system 150 and/or one or more door sensors 704 to determine that the at least one door 120 is positioned in a closed state. In an example embodiment, the computing entity 10 may cause one or more latches 414 and/or locking mechanisms to secure the at least one door 120 in a locked and/or closed state after a human operator and/or a robotic technician has closed the at least one door 120, and subsequently receive an indication that the at least one door 120 is in a locked and/or closed state. The closed state of a door 120 may be defined by various criteria. In an example embodiment, the criteria defining the closed state of a door 120 is configurable, and for example, based on components of an environmental control chamber device 100. For example, the closed state of a door 120 may be defined by at least one of (i) the angle of the door 120 with a respective lateral face 404 being less than a pre-determined threshold angle, (ii) the amount of compression of a peripherally-lined seal 702 being greater than a pre-determined threshold compression amount, or (iii) a latch 414 securing the door 120. In various example embodiments, criteria defining the closed state of a door 120 (and the open state of the door 120) may be evaluated by a door sensor 704, door control system 150, environmental control device controller 110, computing entity 10, and/or the like.

Following operation 904, operation 906 may be performed. Operation 906 comprises determining an operation pressure and an operation temperature for the vacuum chamber 102. In various example embodiments, the computing entity 10 and/or environmental control device controller 110 comprise means, such as processing elements 808 and 112, memory 822, 824, and 114, communication interface 820 and 116, user interfaces 816 and 818, and/or the like, for determining an operation pressure and an operation temperature for the vacuum chamber 102. For example, a computing entity 10 may determine an operation pressure and an operation temperature based on user input received (e.g., via a keypad 818). In another non-limiting example, the environmental control device controller 110 may determine an operation pressure and an operation temperature based on a retrieved pressure value and a retrieved temperature value from memory 114, such as a default vacuum pressure and a default cryogenic temperature. The determined operation pressure and the determined operation temperature may be based on the payload inserted into the vacuum chamber 102 and/or one or more actions to be performed by and/or on the payload. For example, an operation temperature may be determined based on a reaction to be performed on and/or by the payload at a specific reaction temperature. For example, an operation pressure and an operation temperature may be determined based at least in part on pre-determined testing parameters for system-level testing and/or component-level testing. For example, an operation pressure and an operation temperature may be determined based at least in part on pre-determined experiment parameters for physics-related experiments.

Operation 908 may then be performed. Operation 908 comprises causing the interior volume 604 of the vacuum chamber 102 to have the determined operation pressure and the determined operation temperature. In various example embodiments, the computing entity 10 and/or environmental control device controller 110 comprise means, such as processing elements 808 and 112, memory 822, 824, and 114, communication interface 820 and 116, user interfaces 816 and 818, and/or the like, for causing the pressure and temperature within at least a portion of the volume within the interior volume 604 of the vacuum chamber 102 to be the determined operation pressure and the determined operation temperature. For example, the environmental control device controller 110 may interface with a pressure control system 130 via a respective system interface 118 to cause the pressure control system 130 to control the pressure within the interior volume 604 of the vacuum chamber 102 such that the pressure within the interior volume 604 is the determined operation pressure. For example, the pressure control system 130 may be caused to pump air in and/or out of the interior volume 604 of the vacuum chamber 102 (e.g., via ducts or pipes connected to access ports 418) until the interior volume 604 is at the determined operation pressure. As another example, the environmental control device controller 110 may interface with a temperature control system 140 via a respective system interface 118 to cause the temperature control system 140 to control the temperature within the interior volume 604 of the vacuum chamber 102 such that the temperature within the interior volume 604 is the determined operation temperature. The temperature control system 140 may start and/or adjust (e.g., increase) a flow of a temperature control fluid (e.g., liquid nitrogen, helium, hydrogen, and/or other temperature control fluid) into the vacuum chamber 102 to lower the temperature of the interior volume 604 of the vacuum chamber 102 to the determined operation temperature, or increase a voltage and/or current to heating coils in the vacuum chamber 102 to increase the temperature to the determined operation temperature. Therefore, as a result of performing operation 908, the interior volume 604 of the vacuum chamber 102, having the inserted and/or accessed payload disposed therein, may be at the determined operation pressure and the determined operation pressure such that one or more actions may be performed on and/or by the payload.

It will be appreciated that the process flow 900 may be followed by additional operations specific to the payload disposed within the vacuum chamber 102. For example, various actions (e.g., experiments, controlled state evolutions, reactions, function performance, and/or the like) may be performed within the vacuum chamber 102 and on and/or by the payload. Likewise, the payload may be passively stored in the vacuum chamber 102 at the determined pressure and temperature and subsequently observed (e.g., via one or more access ports 418).

Subsequent to any actions performed or an observation period, the environmental control chamber device 100 may be generally operated to remove the payload from the vacuum chamber 102. For example, a process flow may be performed, where the process flow may generally comprise an operation for causing the vacuum chamber 102 to have a pressure and a temperature similar to the pressure and the temperature of the external environment (e.g., a pressure of approximately one atmosphere and a temperature of approximately room temperature). It may be appreciated that such an operation may prevent rapid environmental changes in the interior volume 604 of the vacuum chamber 102 that may damage the payload and/or the vacuum chamber 102 itself. Next, an operation may be performed that may comprise opening at least one door 120 of the environmental control chamber device 100, following which, another operation comprising removing and/or accessing the payload may be performed. A further operation of closing the opened at least one door may be subsequently and optionally performed.

### Technical Advantages

Various embodiments provide technical solutions to technical problems relating to environmental control chambers such as vacuum chambers and/or cryostats. Existing cryogenic chambers, vacuum chambers, environmental control chamber devices experience technical problems such as limited accessibility and long experimental setup times. For example, previous cryogenic chambers may have nested vacuum cans, each of which must be fully removed and/or disassembled in order to place a payload into the chamber and/or to access the payload in order to perform maintenance, make an adjustment, refill a depleted component, and/or the like. Other cryogenic chambers may otherwise require substantial deconstruction or removal of substantially large components to insert a payload and/or provide access to the payload. As a result, significant time and resources are consumed when accessing the interior volume of a cryogenic chamber for tasks such as inserting a payload, manipulating or modifying a payload, removing a payload, and/or the like. Furthermore, removal of substantially large components of existing cryogenic chambers consume a significant amount of physical space, which may impede other actions and tasks performed in the same space (e.g., a lab space).

In the present disclosure, embodiments of an environmental control chamber device with significantly improved accessibility and reduced physical footprint are described. For example, the environmental control chamber device 100 comprises a vacuum chamber, a controller, and at least one door connected to external portions of the vacuum chamber. When positioned in a closed state, the doors are configured to seal openings in the vacuum chamber, thereby enclosing an internal volume and allowing the interior of the vacuum chamber to maintain an operation pressure and an operation temperature, such as a vacuum pressure and a cryogenic temperature. When positioned in an open state, the doors expose the openings in the vacuum chamber, thereby enabling access into the interior volume of the vacuum chamber. As such, a payload may be easily inserted (e.g., via the exposed openings) into the vacuum chamber, conserving magnitudes of time and resources.

Furthermore, the doors are configured to hinge between a closed and an open state, or otherwise remain connected to the vacuum chamber in both states. Therefore, embodiments of the present disclosure provide the advantage of a lower lab footprint, as components of the device do not need to be removed and displaced in order to access the interior volume of the vacuum chamber. As an additional advantage, the doors comprise radiation shields, in various embodiments. Specifically, radiation shields may be inserted within, be a component of, be connected to, and/or the like, the doors. Again, this provides the advantage of conserving significant time, resources, and physical space, as the radiation shields do not have to be individually removed to access the interior volume of the vacuum chamber.

As yet a further technical advantage, embodiments of the environmental control chamber device described herein may be adapted or customized based on various needs. For example, any number of doors may be implemented into an environmental control chamber device based at least on a payload to be inserted, various actions to be performed on the payload and/or the device itself, and/or a physical space within which the environmental control chamber device may be placed or used. As a non-limiting example, a device comprising a vacuum chamber defined by four lateral faces and intended for use in a corner of a lab may be configured to only have doors connected to the lateral faces positioned opposite to the corner. Meanwhile, a similar device intended for use in a relatively open space may comprise four doors for maximum accessibility from multiple directions.

Various embodiments of the present disclosure provide various technical advantages that will be recognized by those of skill in the field to which the present disclosure pertains and that may not be explicitly listed herein. It will be appreciated that the inventors have applied significant effort and ingenuity to overcome various technical challenges in order to provide the various embodiments herein.

### Conclusion

Many modifications and other embodiments of the present disclosure set forth herein will come to mind to one skilled in the art to which the present disclosure pertains, having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. An environmental control chamber device comprising:
a vacuum chamber, the vacuum chamber defined by four or more lateral faces, an upper face, and a lower face, wherein the four or more lateral faces comprises at least one opening;
a controller configured to control a pressure and a temperature within the vacuum chamber; and
at least one door, wherein the at least one door is connected to a respective one of the four or more lateral faces and configured to seal the at least one opening.

2. The environmental control chamber device of claim 1, wherein the controller is configured to control the pressure within the vacuum chamber to a vacuum pressure less than 14.7 psi, and to control the temperature within the vacuum chamber to a cryogenic temperature less than 124 K.

3. The environmental control chamber device of claim 1, wherein:
each lateral face of the four or more lateral faces of the vacuum chamber comprises an opening, and
the environmental control chamber device comprises four or more doors, each door connected to a respective one of the four or more lateral faces and corresponding to the opening of the respective lateral face.

4. The environmental control chamber device of claim 3, wherein:
the vacuum chamber is defined by six lateral faces, an upper face, and a lower face,
each lateral face of the six lateral faces comprises an opening, and
the environmental control chamber device comprises six doors, each door connected to a respective one of the six lateral faces and corresponding to the opening of the respective lateral face.

5. The environmental control chamber device of claim 1, wherein:
the at least one door is moveable between an open state and a closed state,
the at least one door is configured to maintain the pressure and the temperature within the vacuum chamber when positioned in a closed state, and
the at least one door is configured to enable access into the vacuum chamber when positioned in an open state.

6. The environmental control chamber device of claim 5, wherein the at least one door comprises a peripherally-lined seal, the peripherally-lined seal configured to maintain the pressure within the vacuum chamber.

7. The environmental control chamber device of claim 5, wherein the at least one door comprises one or more radiation shields, the one or more radiation shields configured to maintain the temperature within the vacuum chamber and/or the reduce stray electrical and/or magnetic fields within the vacuum chamber.

8. The environmental control chamber device of claim 7, wherein the at least one door comprises two or more radiation shields, the two or more radiation shields being nested or layered radiation shields.

9. The environmental control chamber device of claim 1, wherein the at least one door is connected to a portion of the respective one of the four or more lateral faces external to the vacuum chamber and configured to hinge outwardly from the vacuum chamber.

10. The environmental control chamber device of claim 1, wherein:
the at least one opening is configured to be smaller than a respective lateral face,
the at least one opening is configured such that an area of the at least one opening is maximized, and
the at least one door is dimensioned based at least in part on the at least one opening.

11. The environmental control chamber device of claim 10, wherein the at least one opening is dimensioned based at least in part on a payload to be inserted in the vacuum chamber through the at least one opening.

12. The environmental control chamber device of claim 1, wherein the upper face comprises one or more access ports, the one or more access ports configured to enable access to an interior volume of the vacuum chamber by at least one of (i) electrical wires, (ii) optical fibers or beam paths, (iii) fluid lines, (iv) an optical imaging device, or (v) mechanical feedthroughs.

13. The environmental control chamber device of claim 1, wherein the at least one door and/or at least one of the four or more lateral faces comprises one or more access ports.

14. The environmental control chamber device of claim 13, wherein the one or more access ports are configured to enable access to an interior volume of the vacuum chamber by at least one of (i) electrical wires, (ii) optical fibers or beam paths, (iii) fluid lines, (iv) an optical imaging device, or (v) mechanical feedthroughs.

15. The environmental control chamber device of claim 1, wherein the controller is configured to control movement of the at least one door.

16. The environmental control chamber device of claim 1, wherein the controller is configured to determine a closed or open state of the at least one door through a door sensor.

17. A method of operating an environmental control chamber device comprising a vacuum chamber, a controller, and at least one door, the method comprising:
opening the at least one door, wherein the at least one door is connected to a respective one of four or more lateral faces defining the vacuum chamber;
after a payload has been inserted into an interior volume of the vacuum chamber or accessed within the vacuum chamber through at least one opening of the four or more lateral faces corresponding to the at least one door, determining that the at least one door is closed;
determining an operation pressure and an operation temperature for the vacuum chamber; and
causing the interior volume of the vacuum chamber to have the determined operation pressure and the determined operation temperature.

18. The method of claim 17, wherein:
the determined operation pressure is a vacuum pressure less than 14.7 psi and the determined operation temperature is selected from a range extending from 1.0 mK to 500 K, and
the controller causes a pressure control system and/or a temperature control system to reduce a pressure within the vacuum chamber to the determined operation pressure and/or to reduce a temperature within the vacuum chamber to the determined operation temperature.

19. The method of claim 17, wherein causing the interior volume of the vacuum chamber to have the determined operation pressure and the determine operation temperature is based at least in part on determining that the at least one door is positioned in a closed state based at least in part on a signal generated by a door sensor associated with the at least one door.

20. An apparatus for operating an environmental control chamber device, the apparatus comprising at least one memory and one processor, the at least one memory storing instructions that when executed by the processor, cause the apparatus to:
open at least one door of the environmental control chamber device, wherein the at least one door is connected to a respective one of four or more lateral faces defining a vacuum chamber of the environmental control chamber device;
after a payload has been inserted into an interior volume of the vacuum chamber or accessed within the vacuum chamber through at least one opening of the four or more lateral faces corresponding to the at least one door, determine that the at least one door is closed;
determine an operation pressure and an operation temperature for the vacuum chamber; and
cause the interior volume of the vacuum chamber to have the determined operation pressure and the determined operation temperature.
